(19) United States
(12) Patent Application Publication
(10) Pub. No.: US 2024/0417539 A1
(43) Pub. Date: Dec. 19, 2024

(54) POLYPROPYLENE RESIN COMPOSITION AND MOLDED ARTICLE CONTAINING THE SAME

(71) Applicants: HYUNDAI MOTOR COMPANY, Seoul (KR); KIA CORPORATION, Seoul (KR); KOLON PLASTICS, INC., Gimcheon-si, Gyeongsangbuk-do (KR)

(72) Inventors: Hyeong Won Park, Hwaseong-si (KR); Tae Geun Kim, Seoul (KR); Seong Won Seo, Gimcheon-si (KR)

(73) Assignees: HYUNDAI MOTOR COMPANY, Seoul (KR); KIA CORPORATION, Seoul (KR); KOLON PLASTICS, INC., Gimcheon-si, Gyeongsangbuk-do (KR)

(21) Appl. No.: 18/521,651

(22) Filed: Nov. 28, 2023

(30) Foreign Application Priority Data
Jun. 19, 2023 (KR) 10-2023-0078267

(51) Int. Cl. C08K 3/40; C08K 7/02; C08L 23/12; C08L 23/16; C08L 23/20

(52) U.S. Cl. CPC C08K 3/40; C08K 7/02; C08L 23/12; C08L 23/16; C08L 23/20; C08K 2201/003; C08K 2201/004; C08L 2201/08; C08L 2203/20; C08L 2205/025; C08L 2205/08; C08L 2205/16

(57) ABSTRACT

Disclosed is a polypropylene resin composition that improves chemical stability against external factors because it prevents deterioration of physical properties by moisture and has low surface energy. Disclosed is also a molded article including the polypropylene resin composition that has low ion elution, which is the most important requirement, and can achieve excellent weight reduction.

### CROSS-REFERENCE TO RELATED APPLICATION

The present application claims priority to Korean Patent Application No. 10-2023-0078267, filed on Jun. 19, 2023, the entire contents of which is incorporated herein for all purposes by this reference.

### BACKGROUND OF THE PRESENT DISCLOSURE

### Field of the Present Disclosure

The present disclosure relates to a polypropylene resin composition and a molded article including the same.

### Description of Related Art

In general, a fuel cell vehicle includes a fuel cell stack, an air supply and a thermal management system (TMS). The thermal management system serves to maintain a stack and each component at an appropriate temperature during operation of a fuel cell electric vehicle (FCEV) and increase operational efficiency. In particular, the cathode oxygen depletion heater is a component which plays an important role in rapidly heating a low-temperature coolant during cold start to enable vehicles to rapidly drive even in winter and thereby enhance user convenience and in consuming residual power in the stack when driving is stopped.

The COD heater mainly uses a polyphthalamide resin (PPA-GF35 material), which is expensive and has a problem in that physical properties thereof continuously decrease when exposed to high-temperature coolants, and the electrical conductivity of the coolant increase due to ion elution.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a polypropylene resin composition having stable physical properties.

It is another object of the present disclosure to provide a molded article containing the composition that is lightweight and has chemical resistance, water resistance, and low ion elution.

The objects of the present disclosure are not limited to those described above.

Other objects of the present disclosure will be clearly understood from the following description, and are able to be implemented by means defined in the claims and combinations thereof.

In one aspect, the present disclosure provides a polypropylene resin composition containing a polypropylene resin, a fibrous reinforcing agent, and a surface modifier.

The polypropylene resin composition may contain 100 parts by weight to 120 parts by weight of the fibrous reinforcing agent, and 0.1 parts by weight to 1 part by weight of the surface modifier, based on 100 parts by weight of the polypropylene resin.

The polypropylene resin may have a number average molecular weight (Mn) of 15,000 g/mol to 30,000 g/mol.

The polypropylene resin may contain at least one selected from the group consisting of homopolypropylene, an ethylene propylene copolymer, and a combination thereof.

The polypropylene resin may have a melt index (MI) of 30 g/10 min to 50 g/10 min at 230° C. and a load of 2.16 kg.

The fibrous reinforcing agent may include at least one selected from the group consisting of glass fibers, carbon fibers, graphite fibers, metal fibers, basalt fibers, cotton fibers, wool fibers, silk fibers, aramid fibers, polyacrylonitrile (PAN) fibers, arylate fibers, polyether ether ketone (PEEK) fibers, nylon fibers, polyethylene terephthalate (PET) fibers, and combinations thereof.

The fibrous reinforcing agent may have a length of 6 mm to 25 mm.

The fibrous reinforcing agent may have a diameter of 12 μm to 20 μm.

The surface modifier may include at least one selected from the group consisting of a silicone-based surface modifier, a wax-based surface modifier, a stearate-based surface modifier, and a combination thereof.

The polypropylene resin composition may further contain an additive including at least one selected from the group consisting of a compatibilizer, an impact-resistant agent, a heat-resistant agent, and a combination thereof.

The compatibilizer may include at least one selected from the group consisting of homopolypropylene, an ethylene propylene copolymer, an ethylene octene copolymer, and a combination thereof.

The compatibilizer may be grafted with 0.8 wt % to 1.2 wt % of maleic anhydride, based on the total weight of the compratibilizer.

The compatibilizer may be present in an amount of 1 part by weight to 10 parts by weight, based on 100 parts by weight of the polypropylene resin.

The impact-resistant agent may be present in an amount of 1 part by weight to 5 parts by weight, based on 100 parts by weight of the polypropylene resin.

The heat-resistant agent may include at least one selected from the group consisting of phenol-based heat-resistant agents, phosphorus-based heat-resistant agents, and combinations thereof.

The heat-resistant agent may be present in an amount of 0.1 parts by weight to 1 part by weight, based on 100 parts by weight of the polypropylene resin.

The polypropylene resin composition may have a tensile strength of 140 MPa or more in accordance with ISO 527, a flexural strength of 200 MPa or more in accordance with ISO 178, an impact strength of 25 kJ/m² or more in accordance with ISO 180, and a heat deflection temperature at a load of 1.8 MPa of 158° C. or more in accordance with ISO 75.

In another aspect, the present disclosure provides a molded article including the polypropylene resin composition.

The molded article may include a cathode oxygen depletion (COD) heater.

The molded article may have an ion elution amount of 2.1 ppm or less.

Other aspects and exemplary embodiments of the present disclosure are discussed infra.

### BRIEF DESCRIPTION OF THE DRAWINGS

FIG. 1 shows results of electron microscope analysis of Example 2.

FIG. 2 shows results of electron microscope analysis of Comparative Example 1.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The objects described above, as well as other objects, features and advantages, will be clearly understood from the following exemplary embodiments with reference to the appended drawings. However, the present disclosure is not limited to the embodiments, and may be embodied in different forms. The embodiments are suggested only to offer a thorough and complete understanding of the disclosed contents and to sufficiently inform those skilled in the art of the technical concept of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in the present specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless otherwise defined.

Recently, the automobile industry is focusing on development in various ways to address environmental pollution and improve vehicle efficiency, which are social issues. In an attempt to solve the environmental pollution problem, conventional internal combustion engine vehicles are replaced with electric vehicles and hydrogen fuel cell vehicles. However, weight reduction is more important for eco-friendly vehicles because the weight of the eco-friendly vehicles is increased compared to internal combustion engine vehicles.

Meanwhile, a cathode oxygen depletion (COD) heater is a key component of a hydrogen fuel cell vehicle, which is installed in the coolant line of a fuel cell stack used in a fuel cell vehicle to heat the coolant during start, shutdown, and cold start of the fuel cell stack. Excellent mechanical strength and low ion elution are basically required for materials for the cathode oxygen depletion (COD) heater due to the characteristics of the component.

Ion elution was not highly important for parts that come in contact with antifreeze in internal combustion engine vehicles. However, fuel cell vehicles should minimize ion elution in all parts. Therefore, with conventional polyphthalamide resins, it is disadvantageously difficult to solve the problem of ion elution.

Conventional polyphthalamide resins contain 30 to 40% by weight of short glass fibers with a length of 2 to 3 mm and thus improve thermal stability, but conventional polyphthalamide resin products undergo deterioration in physical properties when exposed to water due to characteristics of the polyphthalamide resin. In addition, the conventional polyphthalamide resins disadvantageously fail to secure high flowability to optimize productivity of injection molds because they use only a modified polyphthalamide resin having a low relative viscosity.

That is, in conventional internal combustion engines, a modified polyamide resin having high thermal stability has been used because the corresponding part has a very high cooling fluid temperature due to the heat generated in the internal combustion engine. On the other hand, fuel cell vehicles generate relatively low heat and thus the degree of temperature increase of the cooling fluid is relatively low. Therefore, the temperature atmosphere enabling application of a general polypropylene resin, as well as a modified amide resin is created. In addition, when a polypropylene resin is used, chemical stability against external factors can be improved due to low surface energy and physical property degradation due to moisture. Furthermore, most importantly, low ion elution and excellent weight reduction can be obtained.

The polypropylene resin composition according to an exemplary embodiment of the present disclosure may contain a polypropylene resin, a fibrous reinforcing agent, and a surface modifier.

Hereinafter, each component of the composition will be described in detail.

### Polypropylene Resin

The polypropylene resin according to an exemplary embodiment of the present disclosure may mean a thermoplastic resin containing an aliphatic molecular chain.

The polypropylene resin may have a number average molecular weight (Mn) of 15,000 g/mol to 30,000 g/mol.

The polypropylene resin may include at least one selected from the group consisting of homopolypropylene, an ethylene propylene copolymer, and a combination thereof.

The polypropylene resin may have a melt index (MI) of 30 g/10 min to 50 g/10 min at 230° C. and a load of 2.16 kg. When the melt index is less than 30 g/10 min, the impregnability with the fibrous reinforcing agent and mechanical properties may be low due to low flowability resulting from the production characteristics of long fiber reinforced thermoplastics (LFT), and when the melt index is higher than 50 g/10 min, the physical properties of the resin itself may be reduced due to the low molecular weight, resulting in poor mechanical properties.

### (B) Fibrous Reinforcing Agent

The fibrous reinforcing agent according to an exemplary embodiment of the present disclosure may include at least one selected from the group consisting of glass fibers, carbon fibers, graphite fibers, metal fibers, basalt fibers, cotton fibers, wool fibers, silk fibers, aramid fibers, polyacrylonitrile (PAN) fibers, arylate fibers, polyether ether ketone (PEEK) fibers, nylon fibers, polyethylene terephthalate (PET) fibers, and combinations thereof, and preferably, may be glass fibers.

The fibrous reinforcing agent may have a length of 6 mm to 25 mm, for example, 7 mm to 20 mm, 8 mm to 18 mm, or 9 mm to 15 mm.

The material currently used for the COD heater housing is a material containing a polyphthalamide resin and 35% by weight of a short-fiber reinforcing agent (glass fiber) with a length of 2 to 3 mm, which is used to produce parts. However, disadvantageously, the material is expensive, undergoes continuous deterioration in physical properties when exposed to high-temperature coolants, and increases the electrical conductivity of the coolant due to ion elution. In order to solve these problems, the functions of the parts are sufficiently performed based on stable physical properties under a mild environment using a material containing a polypropylene resin and 30 to 70% by weight of a long-fiber reinforcing agent (glass fiber) with a length of 6 to 25 mm, and chemical resistance, water resistance, reduced ion elution, and weight reduction are possible due to the change of polymer resin.

The fibrous reinforcing agent may have a diameter of 12 μm to 20 μm.

The content of the fibrous reinforcing agent may be 100 parts by weight to 120 parts by weight, preferably 102.73 parts by weight to 115.85 parts by weight, based on 100 parts by weight of the polypropylene resin. When the content is less than 100 parts by weight, the tensile strength and flexural strength are lowered, and when the content is higher than 120 parts by weight, injection properties are reduced due to defective surfaces of molded articles or decreased flowability.

The fibrous reinforcing agent may be glass fibers and the glass fibers may be in a form of an E-glass roving having wound infinitely long glass fibers. Preferably, silane may be coupled to the surfaces of the glass fibers to secure interfacial adhesion with the final composition.

### (C) Surface Modifier

The surface modifier according to an exemplary embodiment of the present disclosure serves to improve flowability in order to enhance the surface quality of products injected with the polypropylene resin composition.

The surface modifier includes at least one selected from the group consisting of a silicone-based surface modifier, a wax-based surface modifier, a stearate-based surface modifier, and a combination thereof, and may be, for example, a silicone-based surface modifier.

The content of the surface modifier may be 0.1 parts by weight to 1 part by weight, preferably 0.44 parts by weight to 0.66 parts by weight, based on 100 parts by weight of the polypropylene resin. When the content is less than 0.1 parts by weight, it is difficult for the surface modifier to perform the function of surface improvement, and when the content is higher than 1 part by weight, the surface modifier itself may act as an impurity and reduce mechanical properties.

### (D) Additive

The polypropylene resin composition according to an exemplary embodiment of the present disclosure may further contain an additive including at least one selected from the group consisting of a compatibilizer, an impact-resistant agent, a heat-resistant agent, and a combination thereof.

The compatibilizer serves to improve the compatibility between the polypropylene resin and the fibrous reinforcing material.

The compatibilizer may include at least one selected from the group consisting of homopolypropylene, an ethylene propylene copolymer, an ethylene octene copolymer, and a combination thereof.

The compatibilizer may be grafted with 0.8 wt % to 1.2 wt % of maleic anhydride based on the total weight of the compatibilizer.

The content of the compatibilizer may be 1 part by weight to 10 parts by weight, preferably 3.93 parts by weight to 5.90 parts by weight, based on 100 parts by weight of the polypropylene resin. When the content is less than 1 part by weight, disadvantageously, compatibility between the polypropylene resin and the fibrous reinforcing agent may not be increased, resulting in a decrease in mechanical properties, and when the content is higher than 10 parts by weight, the excess compatibilizer may remain unreacted, thus causing deterioration in physical properties of the product.

The impact-resistant agent serves to improve the impact performance of the polypropylene resin composition.

The content of the impact-resistant agent may be 1 part by weight to 5 parts by weight, preferably 2.62 parts by weight to 3.93 parts by weight, based on 100 parts by weight of the polypropylene resin. When the content is less than 1 part by weight, it is difficult to improve the impact performance due to poor overall dispersion of the impact-resistant agent, and when the content is higher than 5 parts by weight, the impact performance may be improved, but the tensile strength, flexural strength and other mechanical properties may be deteriorated.

The heat-resistant agent serves to improve the heat resistance of the polypropylene resin composition.

The heat-resistant agent may include at least one selected from the group consisting of phenol-based heat-resistant agents, phosphorus-based heat-resistant agents, and combinations thereof.

The content of the heat-resistant agent may be 0.1 parts by weight to 1 part by weight, preferably 0.44 parts by weight to 0.66 parts by weight, based on 100 parts by weight of the polypropylene resin. When the content is less than 1 part by weight, the effect of improving heat resistance cannot be obtained, and when the content exceeds 1 part by weight, the effect of improving heat resistance is insignificant in terms of economic efficiency.

In addition, the polypropylene resin composition according to an exemplary embodiment of the present disclosure may further contain an antioxidant, a flame retardant, a fluorescent whitening agent, a plasticizer, a thickener, an antistatic agent, a mold release agent, a pigment, a nucleating agent, and a mixture thereof so long as it does not impair the object of the present disclosure.

A conventional melt-kneading method and device may be used to prepare the polypropylene resin composition. For example, the device used for melt-kneading is a single-screw or twin-screw extruder. When the single-screw or twin-screw extruder is used for homogenous mixing of raw materials, the polypropylene resin and the heat-resistant agent are preferably injected into an inlet because homogenous mixing can be obtained by the shear force of the screw in the extruder. It is preferable to minimize the retention time in a device such as an extruder in order to reduce volatilization of additives during melt-kneading and to maximize physical properties of the composition.

The polypropylene resin composition may be prepared by melt-kneading a polypropylene resin, a heat-resistant agent, and glass fibers as a fibrous reinforcing agent at 230° C. to 300° C. When the temperature of the melt kneading is less than 230° C., it is higher than the melting point of the polypropylene resin, but the flowability is low and sufficient impregnation cannot be obtained, and when the temperature of the melt kneading is higher than 300° C., the additive or polypropylene resin may be thermally decomposed or volatilized, resulting in deterioration in quality.

In addition, in order to improve the rigidity of the polypropylene resin composition, an impregnation process is performed such that the glass fiber, which is a fibrous reinforcing agent, is continuously released from a separate shelf and injected into an impregnation die, rather than through the same extruder, and the injected resin and the polypropylene resin composition are fed into the impregnation die to fill the gaps between the filaments of the bundles of glass fibers through shear force.

The polypropylene resin composition according to an exemplary embodiment of the present disclosure has a tensile strength of 140 MPa or more in accordance with ISO 527, a flexural strength of 200 MPa or more in accordance with ISO 178, an impact strength of 25 KJ/m² or more in accordance with ISO 180, and a heat deflection temperature of 158° C. or more at a load of 1.8 MPa in accordance with ISO 75.

In another aspect, the present disclosure is directed to a molded article including the polypropylene resin composition described above.

The application of the molded article is not limited and the molded article may be applied to a cathode oxygen depletion (COD) heater.

The COD heater including the polypropylene resin composition according to an exemplary embodiment of the present disclosure has excellent chemical resistance and water resistance, low ion elution and light weight based on stable physical properties under a mild environment.

The molded article may have an ion elution amount of 2.1 ppm or less.

Hereinafter, the present disclosure will be described in more detail with reference to the following Examples and Comparative Examples. However, the Examples and Comparative Examples are provided only for better understanding of the present disclosure and thus should not be construed as limiting the scope of the present disclosure.

### Examples 1 to 3 and Comparative Examples 2 to 17

Based on 100 parts by weight of a polypropylene resin (PolyMirae Company Ltd., HP480S), 4.92 parts by weight of a compatibilizer (Woosung Chemical, NB1620), 3.28 parts by weight of an impact-resistant agent (Dow Chemical, Engage 8200), 0.55 parts by weight of a heat-resistant agent (Songwon Industrial, Songnox 1010) and a surface modifier were added in the contents shown in Table 1, and mixed with a twin-screw kneader TEX-44 having a diameter of 44 mm. Here, glass fiber (Owens Corning, SE4121, diameter 15-20 μm), which is a fibrous reinforcing agent fed from a roving, is impregnated in a content shown in Table 1 based on 100 parts by weight of the polypropylene resin to produce a polypropylene resin pellet having a length of 10 mm.

### Comparative Example 1

A polypropylene resin pellet was produced in the same manner as in Example 1, except that the surface modifier was not added.

### Comparative Example 18

A polypropylene resin pellet was produced in the same manner as in Example 1, except that a PA6T/6I (poly(hexamethylene terephthalamide-co-isophthalamide)) resin and glass fiber (short (chopped) glass fiber, diameter of 15 to 20 μm, length of 2 to 5 mm) were used instead of the polypropylene resin and glass fiber (Owens Corning, SE4121, diameter of 15 to 20 μm) of Example 1.

### Comparative Examples 19 to 21

Polypropylene resin pellets were produced in the same manner as in Example 1, except that short (chopped) glass fiber (diameter 15-20 μm, length 2-5 mm) was used as the fibrous reinforcing agent.

TABLE 1

| Unit: | | Fibrous | | Impact- | Heat- | | | |
|---|---|---|---|---|---|---|---|---|
| parts by | | reinforcing | | resistant | resistant | Surface modifier | | |
| weight | PP | agent | Compatibilizer | agent | agent | (A) | (B) | (C) |
| Example 1 | 100 | 109.29 | 4.92 | 3.28 | 0.55 | 0.44 | | |
| Example 2 | 100 | 109.29 | 4.92 | 3.28 | 0.55 | 0.55 | | |
| Example 3 | 100 | 109.29 | 4.92 | 3.28 | 0.55 | 0.66 | | |
| Comparative | 100 | 109.29 | 4.92 | 3.28 | 0.55 | | | |
| Example 1 | | | | | | | | |
| Comparative | 100 | 109.29 | 4.92 | 3.28 | 0.55 | | 0.55 | |
| Example 2 | | | | | | | | |
| Comparative | 100 | 109.29 | 4.92 | 3.28 | 0.55 | | | 0.55 |
| Example 3 | | | | | | | | |
| Comparative | 100 | 109.29 | 4.92 | 3.28 | 0.55 | 0.2 | | |
| Example 4 | | | | | | | | |
| Comparative | 100 | 109.29 | 4.92 | 3.28 | 0.55 | 0.9 | | |
| Example 5 | | | | | | | | |
| Comparative | 100 | 46.84 | 4.92 | 3.28 | 0.55 | 0.44 | | |
| Example 6 | | | | | | | | |
| Comparative | 100 | 46.84 | 4.92 | 3.28 | 0.55 | 0.55 | | |
| Example 7 | | | | | | | | |
| Comparative | 100 | 46.84 | 4.92 | 3.28 | 0.55 | 0.66 | | |
| Example 8 | | | | | | | | |
| Comparative | 100 | 27.32 | 4.92 | 3.28 | 0.55 | 0.44 | | |
| Example 9 | | | | | | | | |
| Comparative | 100 | 27.32 | 4.92 | 3.28 | 0.55 | 0.55 | | |
| Example 10 | | | | | | | | |
| Comparative | 100 | 27.32 | 4.92 | 3.28 | 0.55 | 0.66 | | |
| Example 11 | | | | | | | | |
| Comparative | 100 | 72.86 | 4.92 | 3.28 | 0.55 | 0.44 | | |
| Example 12 | | | | | | | | |
| Comparative | 100 | 72.86 | 4.92 | 3.28 | 0.55 | 0.55 | | |
| Example 13 | | | | | | | | |
| Comparative | 100 | 72.86 | 4.92 | 3.28 | 0.55 | 0.66 | | |
| Example 14 | | | | | | | | |
| Comparative | 100 | 163.93 | 4.92 | 3.28 | 0.55 | 0.44 | | |
| Example 15 | | | | | | | | |
| Comparative | 100 | 163.93 | 4.92 | 3.28 | 0.55 | 0.55 | | |
| Example 16 | | | | | | | | |
| Comparative | 100 | 163.93 | 4.92 | 3.28 | 0.55 | 0.66 | | |
| Example 17 | | | | | | | | |
| Comparative | 100 | 42.86 | 4.92 | 3.28 | 0.55 | 0.44 | | |
| Example 19 | | | | | | | | |
| Comparative | 100 | 66.67 | 4.92 | 3.28 | 0.55 | 0.44 | | |
| Example 20 | | | | | | | | |
| Comparative | 100 | 100 | 4.92 | 3.28 | 0.55 | 0.44 | | |
| Example 21 | | | | | | | | |

(A): 250H (Sunilchemical. Co., Ltd.)
(B): PE-Wax (Plastic Service Inc.)
(C): Calcium-Stearate (Sinwon Chemical Co., Ltd.)

TABLE 2

| Unit: | | Fibrous | | Impact- | Heat- | | | |
|---|---|---|---|---|---|---|---|---|
| parts by | | reinforcing | | resistant | resistant | Surface modifier | | |
| weight | PPA | agent | Compatibilizer | agent | agent | (A) | (B) | (C) |
| Comparative | 100 | 53.85 | 4.92 | 3.28 | 0.55 | 0.44 | | |
| Example 18 | | | | | | | | |
| (PPA-GF35) | | | | | | | | |

PPA: PA6T/6I (poly(hexamethylene terephthalamide-co-isophthalamide))/Dupont Inc., HTN51G35HSLR

### Experimental Example 1: Comparison in Physical Properties Between Examples and Comparative Examples

The pellets of Examples 1 to 3 and Comparative Examples 1 to 21 produced using an injection molding machine with a clamping force of 170 tons were prepared into specimens in accordance with ISO test standards, and then the flowability of the resin, and the tensile strength, the flexural strength, flexural modulus and impact strength of the specimens were measured. The results are shown in Table 3.
Resin temperature setting: 260° C. (260, 255, 250, 245, 245, 240° C.)
Mold temperature setting: 80° C.
Holding pressure: 50 MPa
Holding time: 5 seconds
Cooling time: 15 seconds
Tensile strength: measured in accordance with ISO 527
Flexural strength: measured in accordance with ISO 178
Flexural modulus: measured in accordance with ISO 178
Impact strength: measured in accordance with ISO 180
Heat deflection temperature: measured in accordance with ISO 75
Specific gravity: measured in accordance with ISO 1183-1

TABLE 3

| | | | | Heat | |
|---|---|---|---|---|---|
| | Tensile | Flexural | Impact | deflection | |
| | strength | strength | strength | temperature | Specific |
| | (MPa) | (MPa) | (kJ/m²) | (° C.) | gravity |
| Example 1 | 145 | 206 | 27 | 160 | 1.29 |
| Example 2 | 149 | 210 | 28 | 160 | 1.29 |
| Example 3 | 146 | 207 | 28 | 159 | 1.29 |
| Comparative | 138 | 194 | 21 | 158 | 1.29 |
| Example 1 | | | | | |
| Comparative | 125 | 196 | 19 | 158 | 1.29 |
| Example 2 | | | | | |
| Comparative | 130 | 197 | 18 | 158 | 1.29 |
| Example 3 | | | | | |
| Comparative | 137 | 203 | 24 | 157 | 1.29 |
| Example 4 | | | | | |
| Comparative | 134 | 187 | 22 | 157 | 1.29 |
| Example 5 | | | | | |
| Comparative | 125 | 170 | 26.1 | 159 | 1.10 |
| Example 6 | | | | | |
| Comparative | 128 | 172 | 27.4 | 160 | 1.10 |
| Example 7 | | | | | |
| Comparative | 127 | 174 | 26.2 | 159 | 1.10 |
| Example 8 | | | | | |
| Comparative | 110 | 135 | 16.8 | 157 | 1.02 |
| Example 9 | | | | | |
| Comparative | 113 | 138 | 17.3 | 157 | 1.02 |
| Example 10 | | | | | |
| Comparative | 112 | 138 | 18.4 | 157 | 1.02 |
| Example 11 | | | | | |
| Comparative | 135 | 190 | 26.4 | 160 | 1.18 |
| Example 12 | | | | | |
| Comparative | 138 | 184 | 27.1 | 160 | 1.18 |
| Example 13 | | | | | |
| Comparative | 132 | 194 | 26.9 | 160 | 1.18 |
| Example 14 | | | | | |
| Comparative | 155 | 210 | 24.5 | 161 | 1.42 |
| Example 15 | | | | | |
| Comparative | 159 | 208 | 26.4 | 161 | 1.42 |
| Example 16 | | | | | |
| Comparative | 162 | 215 | 24.8 | 161 | 1.42 |
| Example 17 | | | | | |
| Comparative | 214 | 220 | 9.9 | 261 | 1.45 |
| Example 18 | | | | | |
| Comparative | 105 | 140 | 10 | 155 | 1.12 |
| Example 19 | | | | | |
| Comparative | 114 | 161 | 11 | 155 | 1.2 |
| Example 20 | | | | | |
| Comparative | 134 | 185 | 12 | 157 | 1.31 |
| Example 21 | | | | | |

As can be seen from the above results, as the content of the surface modifier increases (in Examples 1 to 3 compared to Comparative Example 1), the flowability of the resin is improved, thus causing the resin to be readily impregnated with the filaments in the glass fiber bundle and improvement in the mechanical properties.

In addition, when the surface modifier is not added as in Comparative Example 1, the flowability of the resin is low, the impregnation into the filaments in the glass fiber bundle is reduced, and the mechanical properties are relatively poor. As in Comparative Examples 4 and 5, when the content of the surface modifier is excessively low or high, the mechanical strength is also significantly lowered.

In Comparative Example 18 using a conventional polyphthalamide (PPA) resin, it can be seen that the mechanical properties are slightly insufficient and the specific gravity is high. Therefore, when a polypropylene resin is applied instead of a polyphthalamide resin as in the present disclosure, a weight reduction effect can be expected.

Comparing Examples 1 to 3 with Comparative Examples 1 to 5, similar specific gravity results were obtained using fibrous reinforcing agents having the same content, but Examples 1 to 3 have higher strength than Comparative Examples 1 to 5 and thus enable production of parts with stronger mechanical properties without an increase in weight.

In addition, although the type of surface modifier is not particularly limited, it can be seen that Examples 1 to 3 using a silicone-based surface modifier exhibit slightly better physical properties than Comparative Example 2 using a wax-based surface modifier and Comparative Example 3 using a stearate surface modifier.

### Experimental Example 2: Comparison in Surface Quality

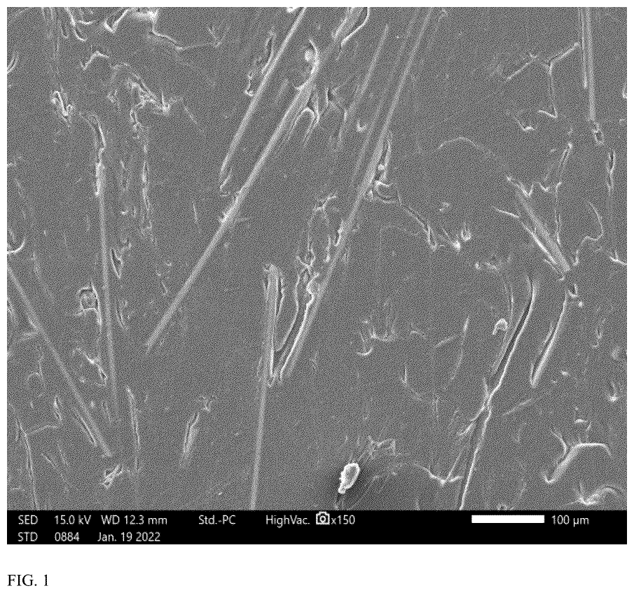

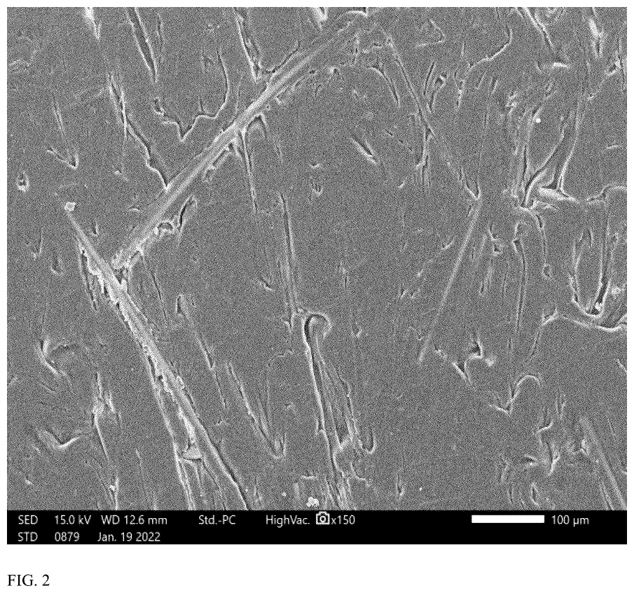

The surface qualities of the injected products using the compositions of Example 2 and Comparative Example 1 were measured with an electron microscope at a magnification of 150 times. The results are shown in FIG. 1 and FIG. 2.

FIG. 1 shows the result of electron microscope analysis of Example 2. FIG. 2 shows the result of electron microscope analysis of Comparative Example 1. It can be seen that the surface roughness of Example 2 to which the surface modifier is added is greatly improved compared to Comparative Example 1 to which the surface modifier is not added.

### Experimental Example 3: Comparison of Tensile Strength Depending on Coolant Temperature

The pellets of Example 2 and Comparative Example 18, which were produced using an injection molding machine with a clamping force of 170 tons, were produced into specimens, and then the tensile strength thereof depending on the temperature of the coolant was measured. The results are shown in Table 4.

TABLE 4

| | |
|---|---|
| | Tensile strength (MPa) |
| Tensile | after 100° C. coolant aging |

| | strength | 500 | 1000 | 2000 | 3000 |
|---|---|---|---|---|---|
| | (MPa) | hours | hours | hours | hours |
| Example 2 | 149 | 150 | 151 | 148 | 148 |
| Comparative | 214 | 182 | 180 | 162 | 141 |
| Example 18 | | | | | |

| | |
|---|---|
| | Tensile strength (MPa) |
| Tensile | after 110° C. coolant aging |

| | strength | 500 | 1000 | 2000 | 3000 |
|---|---|---|---|---|---|
| | (MPa) | hours | hours | hours | hours |
| Example 2 | 149 | 150 | 149 | 146 | 145 |
| Comparative | 214 | 162 | 151 | 135 | 121 |
| Example 18 | | | | | |

| | |
|---|---|
| | Tensile strength (MPa) |
| Tensile | after 120° C. coolant aging |

| | strength | 500 | 1000 | 2000 | 3000 |
|---|---|---|---|---|---|
| | (MPa) | hours | hours | hours | hours |
| Example 2 | 149 | 163 | 157 | 157 | 156 |
| Comparative | 214 | 145 | 127 | 117 | 82 |
| Example 18 | | | | | |

It can be seen from Experimental Example 2 that Example 2, to which the surface modifier was added, has a higher surface quality than Comparative Example 18 to which the surface modifier is not added. As a result, it is possible to minimize the gap between the fibrous reinforcing agent and the polypropylene resin exposed to the surface under a high-temperature antifreeze environment, and to prevent a decrease in physical properties of the surface layer of the glass fiber reinforced injection-molded product, which may be incorporated in the gap and weakened. That is, addition of the surface modifier can prevent deterioration in physical properties under a high-temperature antifreeze environment.

Due to the molecular structure thereof, polypropylene resins minimize chemical reactions by coolant (antifreeze 50 wt %+water 50 wt %) and thus extremely limit the deterioration of mechanical properties even when exposed to high-temperature coolant for a long time. Meanwhile, among polyamide resins (PA), polyphthalamide (PPA) is hydrolyzed in the high-temperature coolant due to the nature of amide-based materials and undergoes continuous deterioration in mechanical properties. Based thereon, it can be seen that the polypropylene resin material is more advantageous than the polyphthalamide resin material in a high-temperature coolant environment.

### Experimental Example 4: Comparison of Ion Elution

The ion elution of molded articles (COD heaters) containing the polypropylene resin compositions of Example 2 and Comparative Example 18 was evaluated. The results are shown in Table 5.

Measurement method: measured in accordance with MS211-80 (ion elution evaluation) and ICP-AES (inductively coupled plasma atomic emission spectroscopy)

TABLE 5
Ion elution amount (ppm)

| DI-water (reference) | Example 2 | Comparative Example 18 |
|---|---|---|
| 0.4 | 2.1 | 82 |

Example 2 has a lower processing temperature than Comparative Example 18 using a PPA resin, undergoes a decrease in an environmental temperature from an internal combustion engine environment to a hydrogen vehicle environment, and requires less heat resistance to exclude addition of a heat stabilizer containing metallic ions and an antioxidant and thereby to improve ion elution compared to the related art.

As is apparent from the foregoing, the polypropylene resin composition according to an exemplary embodiment of the present disclosure can improve chemical stability against external factors because it prevents deterioration of physical properties by moisture and has low surface energy. Furthermore, the molded article including the polypropylene resin composition has low ion elution, which is the most important requirement, and can achieve excellent weight reduction.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A polypropylene resin composition comprising:
a polypropylene resin;
a fibrous reinforcing agent; and
a surface modifier.

2. The polypropylene resin composition of claim 1, wherein the polypropylene resin composition comprises:
based on 100 parts by weight of the polypropylene resin, 100 parts by weight to 120 parts by weight of the fibrous reinforcing agent; and
0.1 parts by weight to 1 part by weight of the surface modifier.

3. The polypropylene resin composition of claim 1, wherein the polypropylene resin has a number average molecular weight (Mn) of 15,000 g/mol to 30,000 g/mol.

4. The polypropylene resin composition of claim 1, wherein the polypropylene resin comprises at least one selected from the group consisting of homopolypropylene, an ethylene propylene copolymer, and a combination thereof.

5. The polypropylene resin composition of claim 1, wherein the polypropylene resin has a melt index (MI) of 30 g/10 min to 50 g/10 min at 230° C. and a load of 2.16 kg.

6. The polypropylene resin composition of claim 1, wherein the fibrous reinforcing agent comprises at least one selected from the group consisting of glass fibers, carbon fibers, graphite fibers, metal fibers, basalt fibers, cotton fibers, wool fibers, silk fibers, aramid fibers, polyacrylonitrile (PAN) fibers, arylate fibers, polyether ether ketone (PEEK) fibers, nylon fibers, polyethylene terephthalate (PET) fibers, and combinations thereof.

7. The polypropylene resin composition of claim 1, wherein the fibrous reinforcing agent has a length of 6 mm to 25 mm.

8. The polypropylene resin composition of claim 1, wherein the fibrous reinforcing agent has a diameter of 12 μm to 20 μm.

9. The polypropylene resin composition of claim 1, wherein the surface modifier comprises at least one selected from the group consisting of a silicone-based surface modifier, a wax-based surface modifier, a stearate-based surface modifier, and a combination thereof.

10. The polypropylene resin composition of claim 1, further comprising an additive comprising at least one selected from the group consisting of a compatibilizer, an impact-resistant agent, a heat-resistant agent, and a combination thereof.

11. The polypropylene resin composition of claim 10, wherein the compatibilizer comprises at least one selected from the group consisting of homopolypropylene, an ethylene propylene copolymer, an ethylene octene copolymer, and a combination thereof.

12. The polypropylene resin composition of claim 10, wherein the compatibilizer is grafted with 0.8 wt % to 1.2 wt % of maleic anhydride, based on a total weight of the compatibilizer.

13. The polypropylene resin composition of claim 10, wherein the compatibilizer is present in an amount of 1 part by weight to 10 parts by weight, based on 100 parts by weight of the polypropylene resin.

14. The polypropylene resin composition of claim 10, wherein the impact-resistant agent is present in an amount of 1 part by weight to 5 parts by weight, based on 100 parts by weight of the polypropylene resin.

15. The polypropylene resin composition of claim 10, wherein the heat-resistant agent comprises at least one selected from the group consisting of phenol-based heat-resistant agents, phosphorus-based heat-resistant agents, and combinations thereof.

16. The polypropylene resin composition of claim 10, wherein the heat-resistant agent is present in an amount of 0.1 parts by weight to 1 part by weight, based on 100 parts by weight of the polypropylene resin.

17. The polypropylene resin composition of claim 1, wherein the polypropylene resin composition has a tensile strength of 140 MPa or more in accordance with ISO 527, a flexural strength of 200 MPa or more in accordance with ISO 178, an impact strength of 25 kJ/m² or more in accordance with ISO 180, and a heat deflection temperature of 158° C. or more at a load of 1.8 MPa in accordance with ISO 75.

18. A molded article comprising the polypropylene resin composition of claim 1.

19. The molded article of claim 18, wherein the molded article comprises a cathode oxygen depletion (COD) heater.

20. The molded article of claim 18, wherein the molded article has an ion elution amount of 2.1 ppm or less.
